(19) United States
(12) Patent Application Publication
(10) Pub. No.: US 2004/0247834 A1
(43) Pub. Date: Dec. 9, 2004

(54) Foaming mold for a composite part

(76) Inventors: Matthias Ludwig, Vechelde (DE); Marcus Lutz, Gifhorn (DE); Frank Niebuhr, Wilsche (DE); Harald Batke, Gerstenbuttel (DE)

Correspondence Address: CARLSON, GASKEY & OLDS, P.C., 400 WEST MAPLE ROAD, SUITE 350, BIRMINGHAM, MI, 48009, US

(21) Appl. No.: 10/855,035

(22) Filed: May 27, 2004

(30) Foreign Application Priority Data
Jun. 3, 2003 (DE) 103 25 097.2

(51) Int. Cl. B29D 9/00

(52) U.S. Cl. 428/157; 428/156

(57) ABSTRACT

A foaming mold for forming a composite part has a first mold part and a second mold part. The first mold part and the second mold part delimit a mold cavity between them. A vent groove is disposed in one of the mold parts and collects any gas trapped in the mold cavity. A plurality of overflow channels are provided between the vent groove and the mold cavity.

### REFERENCE TO RELATED APPLICATIONS

The present invention claims the benefit of German Patent Application No. 103 25 097.2, filed Jun. 3, 2003.

### TECHNICAL FIELD

The invention relates to a foaming mold having a first mold part and a second mold part, which delimit a mold cavity between them. More particularly, the invention relates to a foaming mold for producing vehicle body parts or add-on components such as doors, hoods, bumpers or other components having a substrate and an expandable plastic material applied on the substrate.

### BACKGROUND OF THE INVENTION

A vehicle body part is usually produced by placing a substrate in a first mold part of an open foaming mold. A predetermined amount of an expandable plastic material is then applied on the substrate. The substrate is preferably impervious to the plastic material. A second mold part is then placed tightly on the first mold part to close the foaming mold and define a mold cavity. During the process of closing the foaming mold, some air will inevitably be trapped in the mold cavity. When the expandable plastic material in the foaming mold reacts and expands during a foaming process, the trapped air travels to a parting plane between the first mold part and the second mold part. As a result, air inclusions tend to remain at an edge area of the mold cavity. This air may create air pockets in the plastic material after it is expanded, increasing the risk of surface defects and/or voids in a final molded vehicle body part.

There is a desire for a foaming mold structure that can produce a vehicle body part having better quality.

### SUMMARY OF THE INVENTION

The invention is directed to a foaming mold having a first mold part and a second mold part that delimit a mold cavity therebetween. At least one of the first and second mold parts has a vent groove that collects any gases trapped in the mold cavity. A plurality of overflow channels are provided between the vent groove and the mold cavity. The overflow channels are arranged to guide any air inclusions in the mold cavity to the vent groove. The air can therefore be carried away from the mold cavity.

The overflow channels may be disposed around the mold cavity at regularly spaced intervals or may be arranged specifically at areas where air inclusions are expected. Thus, the air inclusions will be effectively transported away from the mold cavity and discharged into the vent groove.

Advantageous designs of the invention will be apparent from the sub-claims.

### BRIEF DESCRIPTION OF THE DRAWINGS

The invention will be described below with the aid of an embodiment illustrated in the attached drawings in which:

FIG. 1 shows a schematic sectional view of a foaming mold in the closed state according to one embodiment of the invention;

FIG. 2 shows a plan view of one of the mold parts of FIG. 1;

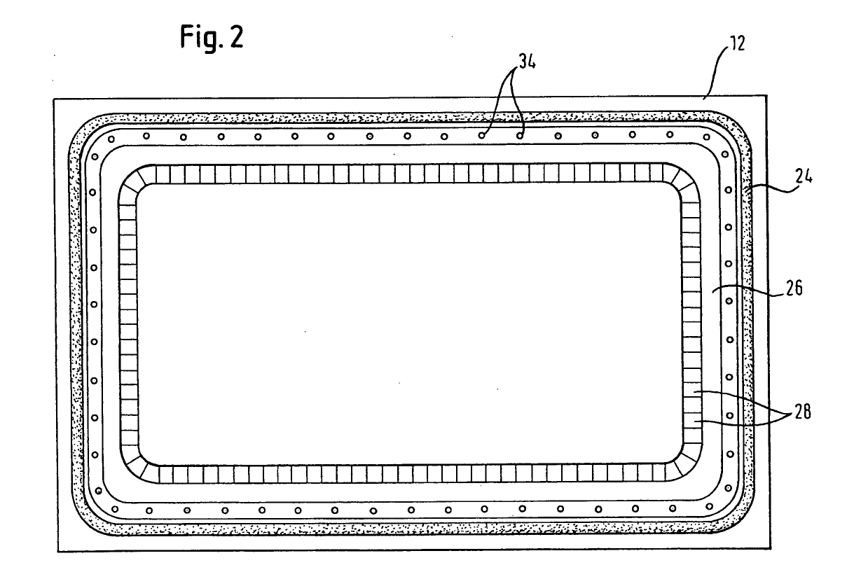

FIG. 3 shows on an enlarged scale a detail III of FIG. 1;

FIG. 4 shows on an enlarged scale a region IV of FIG. 3, where a substrate is arranged in the mold cavity and an expandable plastic material is applied on the substrate; and

FIG. 5 shows a section along a plane V-V of FIG. 4.

### DETAILED DESCRIPTION OF THE PREFERRED EMBODIMENT

The invention is generally directed to a foaming mold having a first mold part and a second mold part that delimit a mold cavity therebetween. At least one of the first and second mold parts has a vent groove that collects any gases trapped in the mold cavity. A plurality of overflow channels are provided between the vent groove and the mold cavity. The overflow channels are arranged to guide any air inclusions in the mold cavity to the vent groove. The air can therefore be carried away from the mold cavity.

In one embodiment, the vent groove surrounds the mold cavity and the plurality of overflow channels connects an interior space of the mold cavity with the vent groove at regularly spaced intervals or in some other configuration. Depending on the geometry of the mold cavity, the overflow channels may instead be arranged specifically at areas where air inclusions are expected to be found. Thus, the air inclusions will be effectively transported away from the mold cavity and discharged into the vent groove.

The vent groove may communicate with at least one negative pressure line. The negative pressure line is particularly effective in drawing the air inclusions out of the mold cavity. The negative pressure created by the negative pressure line also causes the expandable plastic material to be driven outward toward the external regions of the mold cavity, even in areas that are ordinarily difficult to reach. As a result, the mold cavity is completely filled with the expandable plastic material in a desired manner to produce a component without any voids or defects.

In one embodiment, ribs are formed between neighboring overflow channels in one mold part and lie opposite to a positioning face formed in the opposite mold part. A distance between a vertex of a given rib and the positioning face is larger than the thickness of a substrate to be placed in the foaming mold. The ribs fix the substrate in the foaming mold by holding the substrate loosely on the positioning face rather than clamping the substrate firmly against the positioning face. In other words, the ribs prevent the substrate from moving too far away from the positioning face without holding the substrate so tightly that it cannot shift while the plastic material is expanding.

A seal may be arranged in the first or second mold part to delimit the mold cavity or the vent groove. The seal communicates with a pressure line so that the seal can be applied by a variable pressure. In this way, the substrate, which is placed in the foaming mold and has its edge extending beyond a contact region between the first and second mold parts, can be clamped with a variable force.

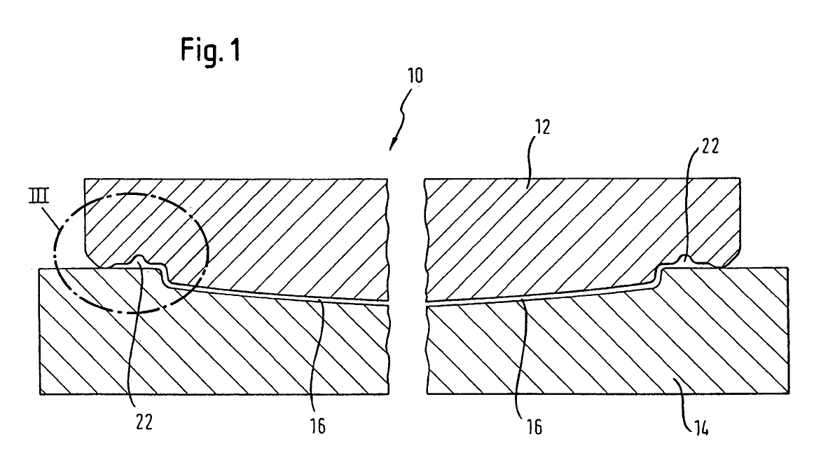

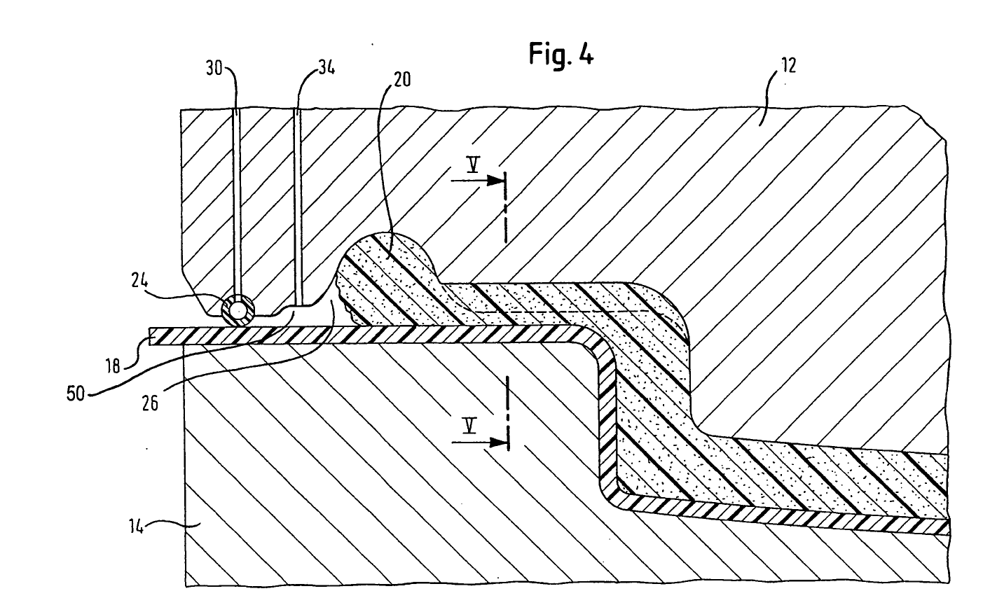

Referring to the figures, FIG. 1 illustrates one embodiment of a foaming mold 10 that comprises a first mold part 12 and a second mold part 14. The first and second mold parts 12, 14 contact each other in a vicinity of their respective outer peripheries to delimit a mold cavity 16 between them. A substrate 18, such as a thermoplastically formable plastic film, can be arranged in the mold cavity 16. An expandable plastic material 20 can in turn be arranged on the substrate 18 (FIG. 4). The substrate 18 and the expandable plastic material 20 join in the mold cavity 16 to form a stable composite part. The composite part may be a vehicle body part such as, for instance, a roof module.

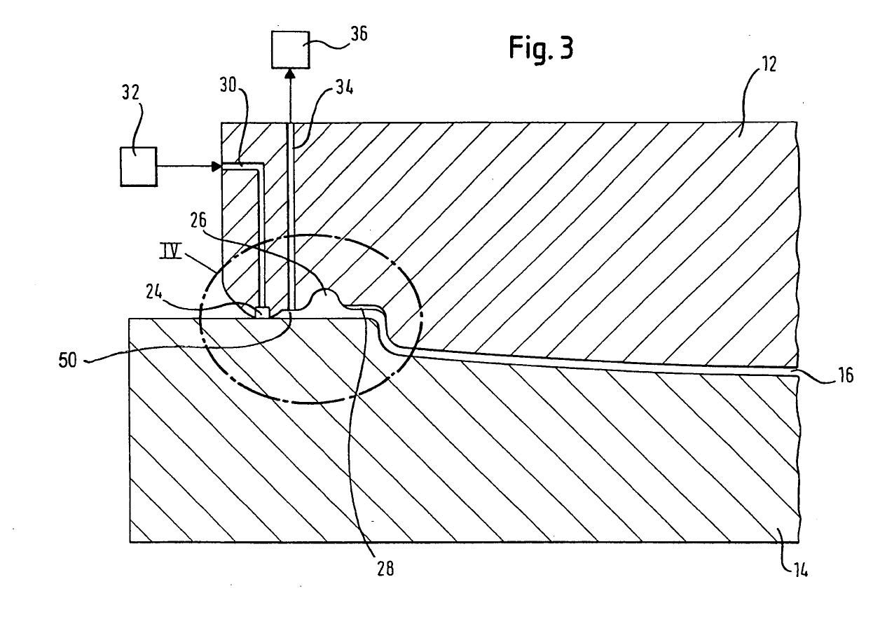

In one embodiment, the mold cavity 16 has a slightly arched, flat shape with edge areas 22 having a step-like, shouldered configuration (FIG. 1). The edge areas 22 are disposed above middle areas of the mold cavity 16. As shown in FIG. 3, the first mold part 12 has a seal 24, a vent groove 26 and a plurality of overflow channels 28 in areas that delimit the edge areas 22 of the mold cavity 16.

The seal 24 may be made of any resilient material, such as rubber, and has a hollow interior. The hollow interior of the seal 24 communicates with a pressure line 30 (FIG. 4), which in turn communicates with a pressure control device 32 (FIG. 3).

The vent groove 26 comprises a main portion having a cross-section with a shape of a rounded segment profile and a secondary portion 50 that is situated toward the seal 24. The main portion can be configured with a radius of around 15 mm, for example. As shown in FIGS. 3 and 4, negative pressure lines 34 may open at regular intervals into the secondary portion of the vent groove 26. The negative pressure lines communicate with a negative pressure control device 36.

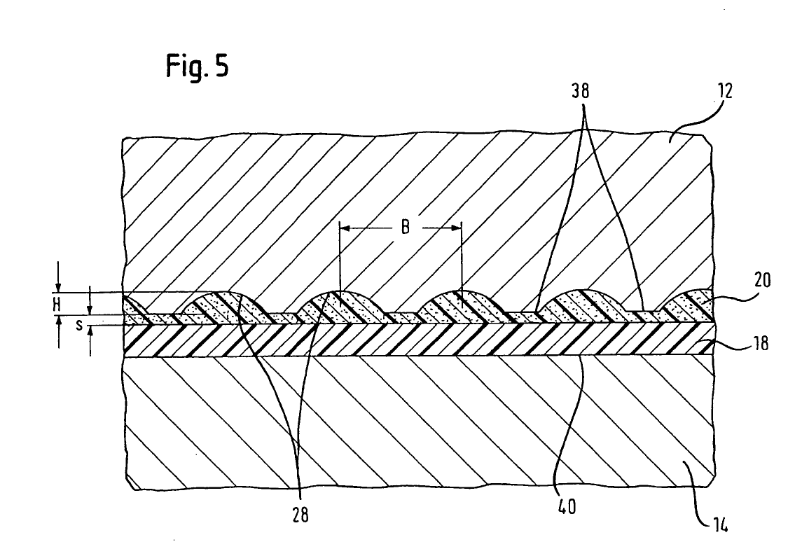

The overflow channels 28 are configured to be adjacent to each other. Together, the overflow channels 28 form a toothed or undulating profile (FIG. 5). A rib or web 38 is formed between each pair of neighboring overflow channels 28. The overflow channels 28 are arranged with a spacing B on the order of, for example, 5 mm, and have a height H on the order of, for example, 0.8 mm. The overflow channels 28 may be configured as rounded segments with a radius of, for example, 2.5 mm. The overflow channels 28 and the ribs 38 are dimensioned such that the vertices of the ribs 38 lie opposite the substrate 18 at a small distance s when the substrate 18 is placed in the foaming mold 10 and when the foaming mold 10 is closed. This distance s is on the order of, for example, 0.2 mm. In this way, the substrate 18 is fixed between the vertices formed by the ribs 38 in the first mold part 12 and areas of the second mold part 14 lying opposite to the vertices in the ribs 38 and acting as a positioning face 40.

The foaming mold 10 described above operates in the following manner. First, when the foaming mold 10 is open, the substrate 18 is placed on the second mold part 14. Next, the expandable plastic material 20 is applied on an upper surface of the substrate 18, and the foaming mold 10 is closed by placing the first mold part 12 onto the second mold part 14. When the foaming mold 10 is closed, the substrate 18 projects outward beyond the seal 24 in the first mold part 12 (FIG. 4) so that the substrate 18 is clamped by the seal 24 against the second mold part 14. The clamping force applied to the substrate 18 can be adjusted by the pressure control device 32.

The expandable plastic material 20 expands during curing and attempts to fill the entire mold cavity 16. During the curing process, any air trapped in the mold cavity 16 is displaced and guided through the overflow channels 28 to the vent groove 26 surrounding the entire mold cavity 16. From there, the air will be carried away from the mold cavity 16 with the assistance of negative pressure in the vent groove 26, which is generated by the negative pressure control device 36. At the same time, the expandable plastic material 20 is pulled into the vent groove 26 by the negative pressure as well (FIG. 4). As shown in FIG. 4, the expandable plastic material 20 travels through the vent groove 26 until the vent groove 26 is completely filled.

Because the overflow channels 28 are arranged substantially uniformly around the mold cavity 16, any trapped air in the mold cavity 16 is carried off reliably and completely to prevent air inclusions from forming in the substrate 18 and the expandable plastic material 20. The overflow channels 28 and the ribs further ensure that the substrate 18 is correctly positioned in the mold cavity 16, particularly in a critical transition area from the middle portion of the mold cavity 16 to the edge areas 22 where the substrate 18 is not clamped in the foaming mold 10. This is of significant importance because the substrate 18 tends to shift slightly in the mold cavity 16 during the expansion of the expandable plastic material 20, particularly if the substrate 18 is a plastic film. If the substrate 18 is clamped too tightly by the ribs 38 around the overflow channels 28, it increases the risk of forming wrinkles or other irregularities in the substrate 18 at the clamped area.

A resulting foamed layer formed by the expandable plastic material 20 will have an edge having a transition portion that follows the undulating shape of the overflow channels 28 shown in FIG. 5 and an end portion that follows the rounded segment shape in the main portion of the vent groove 26 shown in FIG. 4. The end portion will, of course, be thicker than the transition portion due to the thicker profile of the rounded segment shape.

It should be understood that various alternatives to the embodiments of the invention described herein may be employed in practicing the invention. It is intended that the following claims define the scope of the invention and that the method and apparatus within the scope of these claims and their equivalents be covered thereby.

1. A foaming mold comprising:
a first mold part;
a second mold part, the first mold part and the second mold part delimiting a mold cavity therebetween;
a vent groove disposed in at least one of the first mold part and the second mold part and fluidically coupled to the mold cavity to collect gases therein, and
a plurality of overflow channels disposed between the vent groove and the mold cavity.

2. The foaming mold according to claim 1, wherein the vent groove surrounds the mold cavity.

3. The foaming mold according to claim 1, wherein the vent groove is connected to a negative pressure line.

4. The foaming mold according to claim 1, wherein the vent groove has a cross-section with a rounded segment profile.

5. The foaming mold according to claim 1, wherein the plurality of overflow channels are separated from each other by a plurality of ribs.

6. The foaming mold according to claim 5, wherein each of said plurality of ribs has a width that is substantially equal to a width of each of said plurality of overflow channels.

7. The foaming mold according to claim 5, wherein a distance between adjacent ones of said plurality of ribs is approximately 5 mm.

8. The foaming mold according to claim 5, wherein said plurality of ribs are disposed on one of the first mold part and the second mold part, wherein the other of the first mold part and the second mold part has a positioning face, and wherein said plurality of ribs are arranged to lie opposite to the positioning face.

9. The foaming mold of claim 8, wherein a distance between a vertex of at least one of said plurality of ribs and the positioning face is substantially equal to a thickness of a substrate to be placed in the foaming mold.

10. The foaming mold according to claim 9, wherein the distance between the vertex and the positioning face is larger than the thickness of the substrate to be placed in the foaming mold.

11. The foaming mold according to claim 1, wherein each of the plurality of overflow channels has a height of approximately 0.6 mm.

12. The foaming mold according to claim 1, further comprising a seal disposed in one of the first mold part and the second mold part to delimit the mold cavity.

13. The foaming mold according to claim 12 wherein the seal communicates with a pressure line to allow the seal to be applied with a variable pressure.

14. A vehicle component, comprising:
a substrate; and
a foamed layer made of foamed material disposed on the substrate, wherein the foamed layer has an edge having a transition portion with an undulating profile and an end portion that is thicker than the transition portion and that has a rounded segment profile.

15. A method of manufacturing a composite part using a foaming mold having a mold cavity, the method comprising:
placing a substrate in the foaming mold;
applying an expandable material on the substrate;
closing the foaming mold;
expanding and reacting the expandable material; and
applying a negative pressure to the mold cavity.
